(19) United States
(12) Patent Application Publication
(10) Pub. No.: US 2013/0274411 A1
(43) Pub. Date: Oct. 17, 2013

(54) WATER-DISPERSIBLE, AIR-DRYING URALKYD RESINS

(71) Applicant: DSM IP ASSETS B.V., Heerlen (NL)

(72) Inventors: Adriaan HOFLAND, Zwolle (NL); Albertus Ronald HOFKAMP, Enkhuizen (NL); Franciscus Adrianus Cornelis BERGMAN, Zwolle (NL)

(21) Appl. No.: 13/914,489

(22) Filed: Jun. 10, 2013

Related U.S. Application Data
(63) Continuation of application No. 13/625,750, filed on Sep. 24, 2012, now abandoned.
Application No. 13/625,750 is a continuation of application No. 12/523,455, filed on Nov. 9, 2009, now abandoned.

(30) Foreign Application Priority Data
Jan. 18, 2007 (EP) 07001007.9

(51) Int. Cl. C08G 18/32; C09D 175/14

(52) U.S. Cl. CPC C08G 18/3203; C09D 175/14
USPC 524/591; 528/84; 528/80; 427/385.5; 427/393

(57) ABSTRACT

A water-dispersible, air-drying uralkyd resin comprising the reaction product of a) of at least one fatty acid modified polyester polyol comprising components i) at least one unsaturated C₆ to C₃₀ fatty acid; ii) at least one aromatic monocarboxylic acid; iii) at least one (cyclo)aliphatic dicarboxylic acid or (cyclo)aliphatic dicarboxylic anhydride; iv) at least one polyol; b) at least one polyol having a hydroxyl value in the range of from 50 to 350 mgKOH/g; c) at least one polyol bearing ionic and/or potentially ionic water-dispersing groups with a weight average molecular weight≦500 g/mol; and d) at least one polyisocyanate.

This application is a continuation of commonly owned co-pending U.S. application Ser. No. 13/625,750 (now abandoned), filed Sep. 24, 2012, which is a continuation of Ser. No. 12/523,455 (now abandoned), filed Nov. 9, 2009, which is the national phase application under 35 USC §371 of PCT/EP2008/000139, filed Jan. 10, 2008, which designated the U.S. and claims priority to EP Application No. 07001007.9, filed Jan. 18, 2007, the entire contents of each of which are hereby incorporated by reference.

The present invention relates to water-dispersible, air-drying uralkyd resins comprising certain fatty acid modified polyester polyols and aqueous dispersions thereof.

Uralkyd resins are polyurethane polymers formed from reactants comprising a polyisocyanate (normally a diisocyanate) and an unsaturated fatty acid residue-containing ester polyol (normally a diol). The resulting unsaturation in the polyurethane imparts latent crosslinkability so that when a coating composition thereof is dried in the air (often in conjunction with a drier salt) the film coating material undergoes crosslinking, thereby improving its properties, e.g. its chemical resistance, hardness and durability.

The use of such air-drying uralkyds for providing protective surface coatings especially for wooden substrates (e.g. flooring or other wooden surfaces subject to wear) is known.

With regard to the polyester polyol component used for making the uralkyd it is known from for example U.S. Pat. No. 5,126,393 to prepare a polyester polyol from a monocarboxylic acid (including unsaturated fatty acids), aliphatic dicarboxylic acid, aromatic or cycloaliphatic dicarboxylic acid, aliphatic or cycloaliphatic diol and a trihydric or tetrahydric alcohol. The fatty acid modified polyester diol is then further reacted with polyisocyanate and usually other components to form the uralkyd.

U.S. Pat. No. 5,004,779 discloses a solvent based process for preparing aqueous, oxidatively drying alkyd resins for use as binders in aqueous coating compositions.

A disadvantage with such compositions is that the use of aromatic dicarboxylic acids may result in reduced UV-resistance and outdoor durability.

The preparation of polyester polyols for use in solvent based lacquers are also described in DE 2806497 A1 (from a cycloaliphatic acid, trihydric alcohol, unsaturated fatty acid and a monocarboxylic acid) and in U.S. Pat. No. 6,187,384 (from aliphatic or cycloaliphatic alcohols and aliphatic or cycloaliphatic saturated or unsaturated carboxylic acids which are subsequently reacted with fatty acids and isocyanates). A disadvantage with such compositions is that the resultant uralkyds appear to have low hardness development.

The property of water-dispersibility in uralkyd resins, by which is generally understood that the uralkyd resin can self disperse in an aqueous system without the requirement for external surfactants (although these can also be used if desired), has been achieved by building chain-pendant anionic dispersing groups into the resin. Examples of such groups include carboxylic acid groups which, if necessary, are neutralised with bases (usually ammonia or amines) to form anionic salt groups.

We have now discovered certain fatty acid modified polyester polyols which are suitable for the preparation of water-dispersible air-drying uralkyd resins for use in one component coating systems which show improved weather and UV resistance as shown for example by the decay of gloss units over time.

According to the present invention there is provided a water-dispersible, air-drying uralkyd resin having a hydroxyl value in the range of from 0 to 85 mgKOH/g comprising the reaction product of:
a) 50 to 95 wt % of at least one fatty acid modified polyester polyol comprising components:
   i) 20 to 80 wt % of at least one unsaturated C₆ to C₃₀ fatty acid;
   ii) 1 to 40 wt % of at least one aromatic monocarboxylic acid;
   iii) 1 to 50 wt % of at least one (cyclo)aliphatic dicarboxylic acid and/or (cyclo)aliphatic dicarboxylic anhydride;
   iv) 10 to 50 wt % of at least one polyol;
   wherein i)+ii)+iii)+iv)=100%;
b) 0 to 20 wt % of at least one polyol having a hydroxyl value in the range of from 50 to 125 mgKOH/g;
c) 2 to 10 wt % of at least one polyol bearing ionic and/or potentially ionic water-dispersing groups with a weight average molecular weight≦500 g/mol;
d) 5 to 25 wt % of at least one polyisocyanate;
wherein a)+b)+c)+d)=100%.

For clarity the terms polyol, acid, anhydride, polyisocyanate and uralkyd resin are intended to cover the singular as well as the plural.

For clarity (cyclo)aliphatic is intended to include cycloaliphatic and aliphatic.

For clarity the uralkyd resin may comprise components other than components a), b), c) and d) and the fatty acid modified polyester polyol may comprise components other than components i), ii), iii) and iv).

Preferably the uralkyd resin has a hydroxyl value in the range of from 0 to 65 mgKOH/g and more preferably in the range of from 0 to 50 mgKOH/g.

Preferably the fatty acid modified polyester polyol component a) has a hydroxyl value in the range of from 10 to 120 mgKOH/g, more preferably in the range of from 20 to 100 mgKOH/g and especially in the range of from 30 to 99 mgKOH/g.

Suitable C₆ to C₃₀ fatty acids include but are not limited to soybean oil, tall oil fatty acids, palm oil, linseed oil, tung oil, rapeseed oil, sunflower oil, dehydrated castor oil and safflower oil. Preferably the C₆ to C₃₀ fatty acid is soybean oil fatty acid. Preferably the fatty acid modified polyester polyol comprises 25 to 70 wt % and more preferably 25 to 65 wt % of component i).

Suitable aromatic monocarboxylic acids include but are not limited to aromatic monocarboxylic acids such as benzoic acid and para t-butyl benzoic acid.

Preferably the fatty acid modified polyester polyol comprises 5 to 35 wt % and more preferably 5 to 25 wt % of component ii).

Suitable cycloaliphatic dicarboxylic acid and/or cycloaliphatic dicarboxylic anhydrides include but are not limited tetrahydrophthalic acid, tetrahydrophthalic acid anhydride, hexahydrophthalic acid, hexahydrophthalic anhydride, maleic anhydride and succinic anhydride. Preferably the fatty acid modified polyester polyol comprises 5 to 45 wt %, more preferably 5 to 30 wt % of component iii). Preferably component iii) has a molecular weight<160 g/mol.

The fatty acid modified polyester polyol may comprise aliphatic dicarboxylic acids and/or aliphatic dicarboxylic anhydrides.

Preferably the fatty acid modified polyester polyol comprises <15 wt %, more preferably <10 wt % and most preferably <5 wt % of aliphatic dicarboxylic acids and/or aliphatic dicarboxylic anhydrides.

The fatty acid modified polyester polyol may comprise aromatic dicarboxylic acids and/or aromatic dicarboxylic anhydrides. Preferably the fatty acid modified polyester polyol comprises <10 wt %, more preferably <5 wt %, most preferably <2.5 wt % and especially 0 wt % of aromatic dicarboxylic acid and/or aromatic dicarboxylic anhydride. Examples of aromatic dicarboxylic acids and/or aromatic dicarboxylic anhydrides include but are not limited to phthalic acid, phthalic acid anhydride, orthophthalic anhydride, isophthalic acid and terephthalic acid.

Suitable polyols include but are not limited to dihydric alcohols (diols), trihydric alcohols, tetrahydric alcohols such as (di)ethylene glycol, (di)propylene glycol, neopentyl glycol, glycerol, trimethylol ethane, trimethylol propane, pentaerythritol and sorbitol. Preferably the fatty acid modified polyester polyol comprises 10 to 40 wt %, more preferably 10 to 30 wt % of component iv). Preferably the fatty acid modified polyester polyol comprises <25 wt %, more preferably <15 wt % and most preferably <5 wt % of a diol.

The fatty acid modified polyester polyol may be prepared using methods well known in the art (C. R. Martens, Alkyd Resins, Chapman and Hall, 1961) The reaction of components listed above is optionally carried out in the presence of esterification catalysts such as tin soaps. The reaction is preferably carried out by melt or azeotropic condensation, optionally under vacuum, at temperatures of 130° C. to 230° C. with the elimination of water. Xylene or methyl isobutyl ketone may be used as an entraining agent to assist with the removal of water from the reaction mixture.

Preferably the uralkyd resin comprises 60 to 90 wt %, more preferably 70 to 90 wt % of the fatty acid modified polyester polyol component a).

The polyol component b) preferably has a hydroxyl value in the range of from 50 to 250 mgKOH/g. Polyol component b) includes but is not limited to polyols such as polypropylene glycols, poly(propylene oxide/ethylene oxide) copolymers, polytetrahydrofuran, polybutadiene, hydrogenated polybutadiene, polysiloxane, polyamides, polyesters amides, isocyanate-reactive polyoxyethylene compounds, polyester, polyether, polycaprolactone, polythioether, polycarbonate, polyethercarbonate, polyacetal and polyolefin polyols.

Polyether polyols which may be used include products obtained by the polymerisation of a cyclic oxide, for example ethylene oxide, propylene oxide or tetrahydrofuran or by the addition of one or more such oxides to polyfunctional initiators, for example water, methylene glycol, ethylene glycol, propylene glycol, diethylene glycol, cyclohexane dimethanol, glycerol, trimethylopropane, pentaerythritol or Bisphenol A. Especially useful polyether polyols include polyoxypropylene diols and triols, poly (oxyethylene-oxypropylene) diols and triols obtained by the simultaneous or sequential addition of ethylene and propylene oxides to appropriate initiators and polytetramethylene ether glycols obtained by the polymerisation of tetrahydrofuran. Particularly preferred are polypropylene glycols.

Examples of lower molecular weight polyols include ethylene glycol, diethylene glycol, tetraethylene glycol, bis (hydroxyethyl) terephthalate, 1,4-cyclohexane dimethanol, furan dimethanol, glycerol and the reaction products, up to molecular weight 499, of such polyols with propylene and/or ethylene oxide.

Preferably the uralkyd resin comprises 0 to 10 wt %, more preferably 0 to 5 wt % of the polyol component b).

Preferably the polyol component c) comprises anionic or potentially anionic water-dispersing groups. Examples of compounds bearing anionic water-dispersing groups include phosphoric acid groups, sulphonic acid groups and/or carboxylic acid groups such as carboxyl group containing diols and triols. Preferably the polyol comprises dihydroxyalkanoic acids such as 2,2-dimethylolpropionic acid (DMPA) and/or 2,2-dimethylolbutanoic acid (DMBA).

The anionic water-dispersing groups are preferably fully or partially in the form of a salt. Conversion of for example a potentially anionic water-dispersing group to the salt form (i.e. anionic water-dispersing group) may be effected by neutralisation with a base, preferably during the preparation of the aqueous composition of the present invention.

If the anionic water-dispersing groups are neutralised, the base used to neutralise the groups may be selected from ammonia, an amine such as triethylamine, ethanolamine or dimethylethanolamine, an inorganic base and combinations thereof.

Suitable inorganic bases include alkali hydroxides and carbonates, for example lithium hydroxide, sodium hydroxide or potassium hydroxide. A quaternary ammonium hydroxide, for example N⁺(CH₃)₄(OH), can also be used. Generally a base is used which gives counter ions that may be desired for the composition. For example, preferred counter ions include Li⁺, Na⁺, K⁺, NH₄⁺ and substituted ammonium salts.

Neutralisation is usually based on the equivalent of ionic groups, and preferably the ionic water-dispersing groups in the uralkyd resin are neutralised with a neutralising agent in the range of from 0.5:1 to 1.4:1, more preferably 0.6:1 to 1.4:1, most preferably 0.75:1 to 1.30:1 and especially 0.95:1 to 1.25:1. At lower levels not enough of the resin is dispersed leading to an increase in sediment levels and at higher levels an increase in pH may occur, resulting in more isocyanate groups reacting with water. This results in an increase in foam and a reduction in the molecular weight of the uralkyd resin. Additionally at higher levels a discoloration of the resultant coating or substrate may occur especially when applied to certain types of wood such as oak.

Preferably the uralkyd resin comprises 2 to 8 wt %, more preferably 2 to 5 wt % of the polyol carrying ionic or and/or potentially ionic water-dispersing groups. The uralkyd resin preferably has an acid value >8 mg KOH/g. The theoretical acid value of for example a resin comprising 2 wt % of 2,2-dimethylolpropionic acid is calculated as:

561×2 wt % of ionic component/134 mol wt of ionic component=8.4 mgKOH/g.

The polyisocyanate component d) may comprise aromatic or (cyclo)aliphatic polyisocyanates. The term aromatic polyisocyanate (for the sake of clarity) is intended to mean compounds in which all the isocyanate groups are directly bonded to an aromatic group, irrespective of whether aliphatic groups are also present. Examples of suitable aromatic polyisocyanates include but are not limited to p-xylylene diisocyanate, 1,4-phenylene diisocyanate, 2,4-toluene diisocyanate, 2,6-toluene diisocyanate, 4,4′-methylene bis(phenyl isocyanate), polymethylene polyphenyl polyisocyanates, 2,4′-methylene bis(phenyl isocyanate) and 1,5-naphthylene diisocyanate. Preferred aromatic isocyanates include 2,4′-methylene bis(phenyl isocyanate) and 4,4′-methylene bis(phenyl isocyanate). Aromatic polyisocyanates provide chemical resistance and toughness but may yellow on exposure to UV light.

The term (cyclo)aliphatic polyisocyanate (for the sake of clarity) is intended to mean compounds in which all the isocyanate groups are directly bonded to aliphatic or cycloaliphatic groups, irrespective of whether aromatic groups are also present.

Examples of (cyclo)aliphatic polyisocyanates include but are not limited to ethylene diisocyanate, para-tetra methylxylene diisocyanate (p-TMXDI), meta-tetra methylxylene diisocyanate (m-TMXDI), 1,6-hexamethylene diisocyanate, isophorone diisocyanate (IPDI), cyclohexane-1,4-diisocyanate and 4,4′-dicyclohexylmethane diisocyanate. Aliphatic polyisocyanates improve hydrolytic stability, resist UV degradation and do not yellow. Preferred (cyclo)aliphatic iscocyanates include isophorone diisocyanate, 4,4′-dicyclohexylmethane diisocyanate and 1,6-hexamethylene diisocyanate.

Aromatic or aliphatic polyisocyanates which have been modified by the introduction of, for example, urethane, allophanate, urea, biuret, uretonimine and urethdione or isocyanurate residues may be used for polyisocyanate component d).

Preferably the uralkyd resin comprises 5 to 20 wt % and more preferably 10 to 15 wt % of the polyisocyanate component d).

Preferably polyisocyanate component d) comprises 50 to 100 wt %, more preferably 80 to 100 wt % of at least a (cyclo)aliphatic polyisocyanate.

Preferably at least 70 wt %, more preferably at least 85 wt % and most preferably at least 95 wt % of the polyisocyanate component d) has two isocyanate groups.

According to a second embodiment of the present invention there is provided an aqueous dispersion comprising a water-dispersible, air-drying uralkyd resin according to the present invention. For the purposes of this invention an aqueous “dispersion” means a dispersion of the uralkyd resin in a liquid medium comprising at least 50% by weight, more usually at least 80% by weight of water. Minor amounts of organic liquid may be present if desired or required. Preferably the dispersions of the invention comprise ≦1 wt %, more preferably ≦0.5 wt % and especially ≦0.2 wt % of organic solvent by weight of the air-drying uralkyd resin. The aqueous dispersions of the invention typically have a solids content of from about 20 to 60% by weight, more usually from 25 to 50% by weight.

The reaction to form the uralkyd resin may be carried out in a single step, i.e. all the reactants being present at the beginning of the reaction. More usually however, two or more steps are employed, with one or more reactants being added at different stages of the reaction after its commencement.

The uralkyd is conventionally formed by reacting the polyisocyanate component d) with the fatty acid modified polyester polyol component a), the polyol component c) and optionally polyol component b) under substantially anhydrous conditions at a temperature between about 30° C. and about 130° C. until the reaction between the isocyanate groups and the polyols is substantially complete. Catalysts such as dibutyltin dilaurate may be used to assist uralkyd formation.

An organic solvent may optionally be added before, during or after uralkyd resin formation to control the viscosity. Suitable organic solvents which may be used include acetone, methylethylketone, dimethylformamide, diglyme, N-methylpyrrolidone, ethyl acetate, ethylene and propylene glycol diacetates, alkyl ethers of ethylene and propylene glycol diacetates, alkyl ethers of ethylene and propylene glycol monoacetates, toluene, oxylene and sterically hindered alcohols such as t-butanol and diacetone alcohol, and reactive diluents such as vinyl monomers. The preferred solvents are water-miscible solvents. Acetone and methyl ethyl ketone have the advantage that uralkyds often show a good solubility in them and they are easily removed from the composition. Preferably the uralkyd resin is obtained in the presence of ≦1 wt %, more preferably ≦0.5 wt % and especially ≦0.1 wt % of N-methylpyrrolidone by weight of uralkyd. Preferably N-methylpyrrolidone is not used during the uralkyd resin formation.

An aqueous uralkyd resin dispersion is preferably prepared by dispersing the uralkyd resin (optionally carried in an organic solvent medium) in an aqueous medium using techniques well known in the art. Preferably the uralkyd resin is added to the water with agitation, or, alternatively water may be stirred into the uralkyd resin.

The aqueous dispersions comprising the uralkyd resins of the invention are particularly useful as or for providing the principle component of coating compositions (e.g. protective, decorative or adhesive coating compositions) for which purpose they may be further diluted with water and/or organic solvents, or they may be supplied in more concentrated form by evaporation of water and/or organic components of the liquid medium. The dispersions, optionally in the form of coating compositions may be applied to a variety of substrates including wood, board, metals, stone, concrete, glass, cloth, leather, paper, plastics, foam and the like, by any conventional method including brushing, dipping, flow coating, spraying, and the like. They are, however, particularly useful for providing coatings on wood and board substrates. The aqueous medium is removed by natural or accelerated (by heat) drying to form a coating.

The dispersions may contain other conventional ingredients including coalescing organic solvents, pigments, dyes, emulsifiers, surfactants, thickeners, heat stabilisers, levelling agents, anti-cratering agents, fillers, sedimentation inhibitors, UV absorbers, antioxidants and the like introduced at any stage of the production process or subsequently. It is possible to include an amount of antimony oxide in the dispersions to enhance the fire retardant properties.

In particular, the dispersions of the invention advantageously include one or more drier salts. Drier salts are well known to the art for further improving air-curing in unsaturated film-forming substances. Generally speaking, drier salts are metallic soaps, these are salts of metals and long chain carboxylic acids. It is thought that the metallic ions effect the curing action in the film coating and the fatty acid components confer compatibility in the coating medium. The most important drier metals are cobalt, manganese, zirconium, lead and calcium. The level of drier salts in the composition is typically that to provide an amount of metals within the range of from 0.02 to 0.5% by weight based on the weight of the uralkyd resin.

Drier salts are conventionally supplied as solutions in white spirit for use in solvent-borne alkyd systems. They may, however, be used quite satisfactorily in aqueous-based coating dispersions since they can normally be dispersed in such systems fairly easily.

The drier salts may be incorporated into the dispersion at any convenient stage. For example, it may be added to the uralkyd resin, along with the neutralising amine (or ammonia), if used, prior to dispersion into water.

If desired the aqueous dispersion of the invention can be used in combination with other polymer dispersions or solutions which are not according to the invention. For example, it is known to modify the properties of conventional uralkyd resin coatings derived from aqueous dispersions thereof by incorporating vinyl polymers, and in particular acrylic polymers, into the dispersions. While such dispersions may include the polyurethane and vinyl polymers as a simple blend of the preformed polymers, it is also known to form the vinyl polymer in-situ by polymerising one or more vinyl monomers in the presence of an aqueous uralkyd resin dispersion. Such in-situ formation of the vinyl polymer can be advantageous in that it may result in greater stability and may further improve the performance of the resulting coating in comparison to simple blending.

The present invention is now illustrated by reference to the following example. Unless otherwise specified, all parts, percentages and ratios are on a weight basis.

### EXAMPLES

### Fatty Acid Modified Polyester Polyol #1

Soybean fatty acid (560 g), benzoic acid (244 g), pentaerythritol (272 g) and hexahydrophthalic anhydride (154 g) were heated in a reactor at temperatures up to 230 to 240° C. in the presence of xylene (40 g) as an entraining agent, with the azeotropic removal of the reaction product (water) until an acid number of <5 mgKOH/g was reached. After completion of the reaction the azeotropic xylene was removed by vacuum distillation at 200° C. @0.3 bar.

After cooling the resultant fatty acid modified polyester polyol #1 was dissolved in acetone (200 g). The fatty acid modified polyester polyol #1 had a theoretical hydroxyl value of 98 mgKOH/g.

### Fatty Acid Modified Polyester Polyol #2 (Comparative)

A variant of fatty acid modified polyester polyol # 1 was prepared in a similar fashion, by replacing the hexahydrophthalic anhydride (HHPA) by orthophthalic anhydride (PA) on a mole/mole basis.

### Fatty Acid Modified Polyester Polyol #3

Soybean fatty acid (1260 g), benzoic acid (366 g), pentaerythritol (681 g) and hexahydrophthalic anhydride (771 g) were heated in a reactor at temperatures up to 230 to 240° C. in the presence of xylene (90 g) as an entraining agent, with the azeotropic removal of the reaction product (water) until an acid number of <10 mgKOH/g was reached. After completion of the reaction the azeotropic xylene was removed by vacuum distillation at 200° C. @0.3 bar. After cooling the resultant fatty acid modified polyester polyol #3 was dissolved in acetone (950 g). The fatty acid modified polyester polyol #3 had a theoretical hydroxyl value of 49 mgKOH/g.

### Fatty Acid Modified Polyester Polyol #4 (Comparative)

A variant of fatty acid modified polyester polyol # 3 was prepared in a similar fashion, by replacing hexahydrophthalic anhydride (HHPA) by orthophthalic anhydride (PA) on a mole/mole basis.

### Example 1

### Water-Dispersed, Air-Drying Uralkyd Resin #1a

Fatty acid modified polyester polyol #1 (220 g) as prepared above in acetone, DMPA (26 g), Desmodur I, (supplied by Bayer, cycloaliphatic diisocyanate based on IPDI, 3-isocyanatomethyl-3,5,5-trimethylcyclohexyl isocyanate, NCO content 37.5% minimum, 78 g), triethylamine (20 g) and acetone (140 g) were heated in a reactor at 60° C. until the NCO content was 1.5%. The reaction mixture was cooled to 50° C. and fatty acid modified polyester #2 (450 g) as prepared above in acetone was added. The reaction was continued at 60° C. until the NCO content was <0.5%. The resultant uralkyd resin #1a was dispersed in demineralised water (880 g) and the acetone was removed by distillation in the presence of an anti foam agent (BYK 011, supplied by Byk). The resultant dispersion was adjusted with demineralised water to a solids content of 40%.

### Comparative Example 2

### Water-Dispersed, Air-Drying Uralkyd Resin #1b

Following the procedure described in example 1, an aqueous air drying dispersion #1b was prepared, using fatty acid modified polyester polyol #2 instead of fatty acid modified polyester polyol #1 and using fatty acid modified polyester polyol #4 instead of fatty acid modified polyester polyol #3.

### Fatty Acid Modified Polyester Polyol #5

Soybean fatty acid (1219 g), benzoic acid (177 g), pentaerythritol (395 g) and hexahydrophthalic anhydride (195 g) were heated in a reactor at temperatures up to 230 to 240° C. in the presence of xylene (90 g) as an entraining agent, with the azeotropic removal of the reaction product (water) until an acid number of <10 mgKOH/g was reached. After completion of the reaction the azeotropic xylene was removed by vacuum distillation at 200° C. @0.3 bar. The fatty acid modified polyester polyol #5 had a theoretical hydroxyl value of 99 mgKOH/g.

### Fatty Acid Modified Polyester Polyol #6 (Comparative)

A variant of fatty acid modified polyester polyol #5 was prepared in a similar fashion, by replacing hexahydrophthalic anhydride (HHPA) by orthophthalic anhydride (PA) on a mole/mole basis.

### Example 3

### Water-Dispersed, Air-Drying Uralkyd Resin # 2a

Fatty acid modified polyester polyol #4 (418 g) as prepared above, DMPA (23 g), Desmodur I, (supplied by Bayer, cycloaliphatic diisocyanate based on IPDI, 3-isocyanatomethyl-3,5,5-trimethylcyclohexyl isocyanate, NCO content 37.5% minimum, 74 g), triethylamine (33 g) and acetone (300 g) were heated in a reactor at 60° C. until the NCO content was below 0.5%. The reaction mixture was cooled to 50° C. and the resultant uralkyd resin was dispersed in demineralised water (1050g) and the acetone was removed by distillation in the presence of an anti foam agent (BYK 011, supplied by Byk). The resultant dispersion was adjusted with demineralised water to a solids content of 40%.

### Comparative Example 4

### Water-Dispersed, Air-Drying Uralkyd Resin # 2b

Following the procedure described in example 3, an aqueous air drying dispersion #2b was prepared, using fatty acid modified polyester polyol #6 instead of fatty acid modified polyester polyol #5.

The uralkyd resins of the invention (Examples 1 and 3) had a theoretical hydroxyl value <45 mgKOH/g.

The dispersions comprising the uralkyd resins of the invention (Examples 1 and 3) had an organic solvent content <0.1 wt %.

### Paint Preparation

Four white high gloss paints (two comprising examples 1 and 3, and two comprising comparative examples 2 and 4) were prepared from the ingredients listed below in Table 1.

TABLE 1
Millbase:

| | |
|---|---|
| Demineralised water | 15.48 |
| Byk 024 (antifoamer from BYK) | 0.30 |
| Disperbyk 190 (wetting additive from BYK) | 2.16 |
| Acrysol RM 825 (rheology modifier from Rohm & Haas) | 0.74 |
| Kronos 2190 (TiO₂ pigment from Kronos) | 43.38 |
| Millbase Total | 62.06 |
| Demineralised water | 9.69 |
| Dispersion (Example 1, 2, 3, or 4) | 117.51 |
| Acrysol RM 2020 1/1 water (rheology modifier from | 4.00 |
| Rohm & Haas) | |
| Additol VXW 6206 (drier salt available from Cytec) | 0.74 |
| Propyleneglycol | 2.00 |
| White Top Coat Total | 196.00 |

### QUV-B Test

The compositions prepared were formulated as a white paint as described above in Table 1 and when tested by QUV-B (in a UV cabinet from Q Panel Company using an irradiation/condensation cycle) exhibited the following decay of gloss as shown in Table 2 below:

TABLE 2

| Paint prepared with: | Hours until 50% decay of gloss: |
|---|---|
| Example 1 | >600 hours |
| Comparative Example 2 | 300 hours |
| Example 3 | 550 hours |
| Comparative Example 4 | 200 hours |

Examples 1 and 3, based on HHPA, gave significantly better Q-UV-B performance than comparative examples 2 and 4.

### Anti-Blocking

Samples of all 4 paints were applied at 100 μm wet film thickness on Leneta foil. They were dried for 1 day and 7 days at 23° C. and 50% RH (relative humidity). Out of the films, pieces of 2×2 cm were cut and pressed together, paint film facing paint film, for 2 hours at 50° C. A pressure of 250 g/cm² was used. The pieces were separated manually and the degree of damage to the coating (0=very poor, 10=excellent) and the percentage of surface that actually delaminated from the Leneta was assessed. The results were as shown below in Table 3.

TABLE 3

| | Visual | Percentage |
|---|---|---|
| Paint prepared with: | judgement | delamination % |
| Example 1 | 9 | 2 |
| Comparative Example 2 | 6 | 15 |
| Example 3 | 10 | 0 |
| Comparative Example 4 | 8 | 10 |

Examples 1 and 3, based on HHPA, gave significantly better blocking performances than comparative examples 2 and 4.

### Drying Speeds

Drying speed was determined using a BK drying recorder. A pin was drawn through a wet paint film of 100 μm and the shape of the track was observed:

BK phase 1: The paint flows back into the track. The glass substrate is invisible.

BK phase 2: The paint does not flow completely back into the track, the substrate can be seen. The surface of the paint film is not damaged.

BK phase 3: Surface drying is present, through drying not yet. A small series of butterfly-shaped damages can be seen at the surface of the paint film.

BK phase 4: The only damage is a scratch on the surface. At the end of phase 4 a track can no longer be observed.

The results are shown below in Table 4 and show that drying properties are maintained when HHPA is used instead of PA.

TABLE 4

| | End of phase (minutes) | | | |
|---|---|---|---|---|
| | Phase 1 | Phase 2 | Phase 3 | Phase 4 |
| Example 1 | 5 | 10 | 15 | 490 |
| Comparative Example 2 | 5 | 20 | 40 | 430 |
| Example 3 | 10 | 45 | 120 | >720 |
| Comparative Example 4 | 15 | 30 | 150 | >720 |

1. A water-dispersible, air-drying uralkyd resin having a hydroxyl value in the range of from 0 to 85 mg KOH/g comprising the reaction product of:
a) 50 to 95 wt % of at least one fatty acid modified polyester polyol comprising components:
i) 20 to 80 wt % of at least one unsaturated C6 to C30 fatty acid;
ii) 1 to 40 wt % of at least one aromatic monocarboxylic acid;
iii) 1 to 50 wt % of at least one (cyclo)aliphatic dicarboxylic acid and/or (cyclo)aliphatic dicarboxylic anhydride;
iv) 10 to 50 wt % of at least one polyol;
wherein i)+ii)+iii)+iv)=100%;
b) 0 to 20 wt % of at least one polyol having a hydroxyl value in the range of from 50 to 125 mgKOH/g;
c) 2 to 10 wt % of at least one polyol bearing ionic and/or potentially ionic water-dispersing groups with a weight average molecular weight <500 g/mol;
d) 5 to 25 wt % of at least one polyisocyanate;
wherein a)+b)+c)+d)=100%.

2. An air-drying uralkyd resin according to claim 1 having an acid value >8 mg KOH/g.

3. An air-drying uralkyd resin according to claim 1 having a hydroxyl value ≦65 mg KOH/g.

4. An air-drying uralkyd resin according to claim 1 wherein the ionic water-dispersing groups in the uralkyd resin are neutralised with a neutralising agent in an equivalent range of from 0.5:1 to 1.4:1.

5. An air-drying uralkyd resin according to claim 1 wherein the fatty acid modified polyester polyol component a) comprises <15 wt % of aliphatic dicarboxylic acid and/or aliphatic dicarboxylic anhydride.

6. An air-drying uralkyd resin according to claim 1 wherein the fatty acid modified polyester polyol component a) comprises <10 wt % of aromatic dicarboxylic acid and/or aromatic dicarboxylic anhydride.

7. An air-drying uralkyd resin according to claim 1 wherein the fatty acid modified polyester polyol component a) comprises <25 wt % of a diol.

8. An air-drying uralkyd resin according to claim 1 wherein the fatty acid modified polyester polyol component a) has a hydroxyl value in the range of from 10 to 120 mgKOH/g.

9. An air-drying uralkyd resin according to claim 1 wherein the (cyclo)aliphatic dicarboxylic acid or (cyclo)aliphatic dicarboxylic anhydride component iii) has a molecular weight <160 g/mol.

10. An air-drying uralkyd resin according to claim 1 wherein 50 to 100 wt % of the polyisocyanate component d) comprises at least one (cyclo)aliphatic polyisocyanate.

11. An air-drying uralkyd resin according to claim 1 wherein at least 70 wt % of the polyisocyanate component d) has two isocyanate groups.

12. An aqueous dispersion comprising 20 to 60 wt % of an air-drying uralkyd resin according to claim 1 and an aqueous medium.

13. An aqueous dispersion according to claim 12 having an organic solvent content of ≦1 wt % of organic solvent by weight of the air-drying uralkyd resin.

14. An aqueous dispersion according to claim 12 comprising 0.02 to 0.5% by weight of drier salts based on the weight of the air-drying uralkyd resin.

15. A method of coating a substrate using an aqueous dispersion according to claim 12 comprising application of the aqueous dispersion to a substrate and removal of the aqueous medium by drying.

16. A method according to claim 15 where the substrate is wood or board.

17. A substrate having a coating obtained from an aqueous dispersion according to claim 12.
